(19) United States
(12) Patent Application Publication
(10) Pub. No.: US 2021/0187458 A1
(43) Pub. Date: Jun. 24, 2021

(54) MATERIAL MIXTURE SYSTEM WITH BUFFER STORE

(71) Applicant: Rehm Thermal Systems GmbH, Blaubeuren-Seissen (DE)

(72) Inventors: Manuel SCHWARZENBOLZ, Blaubeuren-Beiningen (DE); Thomas ZAH, Laichingen-Suppingen (DE)

(21) Appl. No.: 17/056,880

(22) PCT Filed: May 17, 2019
(86) PCT No.: PCT/EP2019/062754

§ 371 Date: Nov. 19, 2020

(30) Foreign Application Priority Data
May 23, 2018 (DE) 10 2018 208 090.9

(51) Int. Cl. B01F 15/02; B01F 3/08; B01F 3/10; B01F 5/06; B01F 7/08

(52) U.S. Cl. CPC B01F 15/0278; B01F 3/088; B01F 7/082; B01F 5/0614; B01F 3/10

(57) ABSTRACT

A system for mixing two or a plurality of material components, for example for applying onto electronic circuit boards, having a pressure-regulated buffer store downstream of the mixing unit so that a mixing material is pressurized regardless of the quantity contained in the buffer store, even if the inflow and outflow in the buffer store change dynamically.

The present invention refers generally to systems for mixing material fluid streams in order to produce a suitable mixing material having the desired properties for further use, for example for surface treatment.

In many areas of industrial processing, materials are often used which must have special properties to meet the conditions of use. For example, the surfaces of certain products, such as electronic circuit boards and the like, must be sealed and protected. For this purpose, materials in a liquid state are applied using suitable applicators, such as curtain nozzles, simple jet nozzles and the like. Also in many other areas the application of materials with certain properties is required, for example to fill gaps and generally to level surfaces, and the like, whereby usually corresponding starting materials are available in a more or less viscous state and after mixing the mixing material can be applied by appropriate application techniques and then a curing of the material is initiated.

In particular, due to the desired ability of these materials to undergo a curing process in order to achieve the desired final material properties, such materials must be in a suitable state of relatively low viscosity prior to the actual application in order to achieve the desired application behavior during storage and further processing of these materials and during the actual application. For this purpose, two or a plurality of starting materials, which are present in a suitable condition, are often mixed immediately before the actual use of the final material, so that a homogeneously mixing material is produced, but can still be processed for a more or less long period of time. For this purpose, technical solutions are available on the market which offer the possibility to mix two different materials in a freely selectable mixing ratio and thus provide a desired mixing material. The two starting materials as respective mass flows, which typically have a suitably low viscosity each through a respective metering unit which then produces a mixture that is as homogeneous as possible. In these known systems, the mixing material produced from the two mass flows is usually fed to a further unit, such as an applicator unit, which then dispenses the material in a suitable manner, for example by spraying it onto a surface, and the like.

In such known material mixing systems, the two components are each fed in precisely dosed quantities to the mixing unit, which then produces a mixing material according to the supplied mixing ratio of the two starting components. After mixing, a corresponding chemical reaction sets in, which typically leads to an increase in the viscosity of the mixing material and therefore requires a mixing rate adapted to the corresponding “pot life” and the required initial volume flow. The pot life is typically considered to be the time in which the viscosity of a material increases by 100 percent.

Although the mixing rate can be controlled to a certain extent, for example by the speed of the mixing unit, which for instance is provided in the form of a rotating mixing helix, certain inhomogeneities in the amount of material can be detected, especially during certain operating phases, for example at the beginning of a corresponding process for applying mixing material to a product, such as a printed circuit board, since in such phases unusually high dynamics would be required for the corresponding drive motors of the mixing unit and, if necessary, also of the metering units for the material streams to be fed. However, such inhomogeneity of the material to be applied is not acceptable in many applications, so that additional great effort is required to ensure the homogeneity of the applied mixing material layer.

Furthermore, there are also applications with very different dynamic requirements, if, for example, different applicators are to be used for different purposes, so that, if necessary, the dynamic limits set by the mixing unit do not allow reliable use of the same mixing system. For example, so-called curtain nozzles are frequently used in the field of printed circuit board production. These nozzles have a high throughput with a large spray curtain and a low throughput with a small spray curtain and therefore require a correspondingly adapted conveyance of the mixing material, whereby in particular a quick adjustment of the supplied volume flow of the mixing material is required. These requirements of a high dynamics in a wide range of different viscous mixing materials and output volume flows cannot be met or only insufficiently met by known material mixing systems.

It is therefore an object of the present invention to provide a material mixing system with which at least some of the problems mentioned above are eliminated or reduced in their effect.

For the solution of the above-mentioned problem, a material mixing system is specified according to the invention to provide a viscous material system. The material mixing system according to the invention comprises a mixing unit which is configured to mix two or a plurality of inlet material streams to produce a mixing material. The material mixing system further comprises a mixing material buffer store which has an inlet for receiving the mixing material from the mixing unit and an outlet for dispensing the mixing material and which is configured for controlled pressurization of the mixing material.

According to the invention, a buffer store is thus functionally provided downstream the mixing unit, which can receive the mixing material and store it before dispensing, whereby the mixing material in the buffer store can be pressurized in a controlled manner. This means that a required amount of the mixing material can be accumulated by the mixing material buffer store without the mixing material already being dispensed from the storage. The controlled pressurization of the mixing material in the buffer store means that after a certain amount of mixing material has been taken up, it is immediately available with precisely defined conditions and can be dispensed at the outlet and fed to a further processing unit, such as an applicator unit, if necessary via a further pressure control device.

The controllable pressurization, which is, for example, independent of the quantity of the mixing material buffered in the buffer store, therefore allows a precisely defined output pressure of the mixing material stream to be specified, which can thus be maintained independently of the incoming volume flow and the outgoing volume flow. If, for example, an application process is to be started, the stable pressure conditions in the buffer store ensure that precisely defined conditions prevail in the applicator from the very beginning, so that corresponding inhomogeneities, which can occur in conventional material mixing systems, are avoided or at least significantly reduced.

Since the mixing material buffer store can be loaded with the mixing material in sufficient quantity at an early stage, a high dynamic range for corresponding applications can also be guaranteed, since it is possible to apply the mixing material with a volume flow that, for example, exceeds the volume flow of the mixing unit loading the buffer store. In other words, the buffer store can initially be loaded with a quantity of material that is sufficient for one or a plurality of application processes, even if the maximum volume flow achievable by the mixing unit is smaller than the volume flow required for subsequent loading of the applicator. After the buffer store has been emptied to a certain volume at a correspondingly set pressure after completion of a corresponding process, the buffer store is loaded again so that there is sufficient material available for one or more application processes.

In other cases, where the mixing material has to be discharged at a relatively low flow rate, the material supply to the buffer store may be interrupted as soon as the buffer store has reached a suitable filling level and can thus be filled intermittently with mixing material, so that an uninterrupted discharge can take place at the outlet, while always ensuring the desired pressure. In this way, even at low flow rates on the outlet side of the buffer store, reliable mixing operation on the inlet side can be guaranteed, as it is ensured that the corresponding mixing unit operates in a stable operating range.

In another advantageous embodiment, an effective storage volume of the mixing material buffer store can be dynamically adjusted. This means that the required pressure in the buffer store is maintained in a controlled manner without having to maintain a constant storage volume. In other words, the buffer store can be loaded with a variable but adjustable amount of material, while still allowing the internal pressure in the buffer store to be controlled to a predetermined, also variably adjustable target value value. For example, a dynamic determination of the effective storage volume is of particular advantage when an adaptation to a specific application process has to be made. As explained above, different mixing materials, including materials produced from the same starting materials but with different mixing ratios, have different pot lives, which must be taken into account to ensure uniform application of the mixing material and also to avoid excessive curing of the corresponding mixing material in the buffer store and the entire fluid guiding system. If, for example, applications require the application of a quantity of mixing materials, but these materials differ in pot life, a larger effective storage volume of the buffer store can be set for the mixing material with the longer pot life compared to the mixing material with the shorter pot life. In this way, a longer continuous operation can be achieved, if necessary, since the amount of mixing material accumulated in the buffer store can be specially adapted to the application.

In another advantageous embodiment, the mixing material buffer store has a displaceable piston. In this variant, the displaceable piston is a device of simple mechanical construction which can be used for pressurization and dynamic adjustment of the effective storage volume. This means that a simple mechanical construction can be realized, for example by providing a suitable accumulator body, for example in the form of a hollow cylinder, in which the displaceable piston is arranged. The displaceable piston can be used, for example, to pressurize the mixing material by causing direct contact between the mixing material and the piston. In other variants, the displaceable piston can be used to pressurize the mixing material by coupling to the mixing material via an intermediate medium.

In another embodiment, the displaceable piston is connected to a controllable fluid pressure source on the side facing away from the mixing material. The controllable fluid pressure source is to be understood as a source which has a pressurizing fluid which is in connection with the opposite side of the piston and thus applies pressure to this side of the piston and thus to the piston. In advantageous embodiments, the fluid pressure source is formed on the basis of a gas, such as air, nitrogen, and the like, so that in this respect a multitude of well known pneumatic components can be used to connect the fluid pressure source with the mixing material buffer store, so that the piston is pressurized with a corresponding pressure. The fluid pressure source, in turn, can be connected from a large fluid reservoir to corresponding pressure control components, so that a desired pressure is provided by the pressure source.

In other variants, the fluid can also be provided in liquid form, so that in this respect well known conventional hydraulic components can be used to realize the fluid pressure source and to connect it to the buffer store. Here, too, the corresponding pressure control components, compressors, etc. can be used to form the fluid pressure source and/or to supply it with suitable fluid. It is advantageous that the fluid, regardless of whether a liquid and/or one or more gases are considered, is such that it shows an approximately inert behavior with respect to the mixing material, so that even corresponding leaks, which may occur between the piston and the housing of the buffer store, do not cause any significant changes to the mixing material.

In another embodiment, the displaceable piston is connected to a controllable electric or electromagnetic drive device. In this variant, the piston can be moved by direct or indirect connection with the electrical or electromagnetic drive device and thus be pressurized, so that the desired pressure can be applied to the mixing material via the piston by means of the electrical or electromagnetic drive device. For example, linear drive systems, such as linear motors or spindle drives with rotating electric motors, are available which can be controlled in a very precise manner, so that a very precise articulation of the piston based on such drive devices is guaranteed. Typically, electric or electromagnetic drives have a higher energy efficiency than pneumatic or hydraulic drives, so that operating costs may be correspondingly lower, provided that the provision of appropriate electrical components is compatible with the respective operating conditions. In some embodiments, the piston itself can be a component of the electric or electromagnetic drive device, for example, by configuring the piston as the rotor of a linear motor or by providing the piston or part of it as the piston of an electromagnetic drive, for example in the form of an electromagnet.

In a further embodiment, a fluid that is essentially inert for the mixing material can be controllably introduced into the mixing material buffer store to pressurize the mixing material. For this purpose, in one variant the essentially inert fluid can be introduced into the buffer store in such a way that it is directly in contact with the mixing material and therefore serves as a “fluid piston” to exert a force on the mixing material. In the case of an unfilled buffer store, an appropriate valve device may be provided at the inlet and/or outlet of the buffer store, if necessary, so that leakage is prevented if fluid is present. Alternatively or additionally, in further variants, a corresponding source for the pressurizing fluid is configured in such a way that the fluid can be returned to a storage or pressure can be reduced by blowing it off into the environment, if, for example, air or nitrogen are used as pressurizing fluids. The use of a pressurizing fluid in the buffer store results in a mechanically very simple and robust structure, since no mechanically rigid moving parts are required, with the possible exception of valve elements at the inlet and/or outlet. In addition, the pressurizing fluid itself may help to prevent undesired precipitation and curing of the mixing material on the walls of the buffer store. In other cases, the piping available for the supply and, if necessary, discharge of the pressurizing fluid can also be used to introduce a suitable flushing fluid into the buffer store.

In a further advantageous embodiment, the material mixing system is equipped with a volume determination device which is configured to determine the current volume, i.e. the storage volume, of the mixing material in the mixing material buffer store. By determining the current volume of the mixing material, it is possible to reliably maintain suitable operating conditions, since this makes it possible, for example, to avoid an undesired premature emptying of the buffer store, if, for example, an applicator with a relatively high volume flow is to be fed from the buffer store. On the other hand, too large a volume of the mixing material can also be avoided if, for example, with regard to a critical pot life of the mixing material being processed, there is a risk of causing an undesired high viscosity of the mixing material during the dwell time in the buffer store.

The volume determination device is, for example, functionally connected to one or a plurality of sensors, which can be used to retrieve corresponding parameter values in order to determine the current volume of the mixing material. For example, operating parameters of the mixing unit can be fed to the volume determination device, so that the mixing unit serves as a “sensor” that outputs corresponding parameter values that characterize the incoming volume flow at the input of the buffer memory. For example, volumetrically operating metering devices are often used which convey a precisely defined volume flow under fixed working conditions, for example, at a fixed speed of a corresponding metering screw. If the mixing unit, to which the corresponding material streams of the starting materials are fed in a known manner, operates continuously, i.e. there is a balance of incoming material and outgoing material, then it is possible, for example, to determine from the corresponding operating parameters a material quantity per unit of time or a volume flow which is available at the inlet of the buffer store. From this volume flow and the corresponding volume of the respective supply lines between the mixing unit and the buffer store, the volume of the incoming mixing material can thus be determined.

If, on the other hand, corresponding operating parameters of the applicator are known or are currently being fed to the volume determination device, a corresponding output volume flow can also be determined taking into account the volume of the line between the buffer store and the applicator, so that the volume of the mixing material in the buffer store can then be calculated from the two values.

In other variants, in addition or as an alternative to the previously described embodiments, one or a plurality of sensors suitable for direct determination of the volume flow may be provided at suitable points within the supply line and the discharge line of the buffer store, so that these values can be used to determine the current volume of the mixing material in the buffer store. In other advantageous embodiments, for example, the filling level of the mixing material in the buffer store is determined by suitable sensors or operating parameters. If, for example, a displaceable piston is provided in the buffer store, the position of the piston, which is directly in contact with the mixing material, can be determined in order to determine the volume of the mixing material in a precise way. The actual position of the piston can be determined, for example, by means of one or a plurality of optical sensors inside the buffer store, one or a plurality of which are suitably positioned so as not to interfere with the movement of the displaceable piston. In other cases a distance measurement of the piston can be carried out. In other embodiments in which the piston is electrically or electromagnetically controlled, for example by a linear motor, a linear spindle drive, and the like, operating parameters of the drive may be used as “sensor values” to determine the position of the piston. For example, the number of revolutions of a spindle drive can be used to determine the position of the piston in a very precise way with a known pitch of the spindle. Since typically the control of a corresponding drive motor, e.g. a step motor, is done by an electronic control in which the corresponding number of revolutions can be set and read out very precisely, corresponding values can be transmitted to the volume determination device and used to evaluate the piston position.

In an advantageous embodiment, the piston has an indicator element that allows the position of the piston to be determined contact-less. This means that by suitable configuration of at least part of the piston, position information can be transmitted contact-less, so that the costly installation of a sensor within the buffer store can be avoided. For example, a magnet can be provided in the piston so that the position can be detected continuously or step by step by means of a sensor located outside the buffer store. For example, inexpensive reed switches can be attached to the outer surface of the buffer store with suitable resolution and connected so that the respective switch responds when passing a corresponding position. In other embodiments, a continuously operating path sensor can be used in conjunction with a magnetic material to read position values of the piston.

In another advantageous embodiment, a control device is provided, which is at least configured to control the pressurization of the mixing material. This means that the control device is capable of approximately maintaining at least the pressure in the buffer store, which acts on the mixing material, on the basis of an adjustable target value independent of the quantity of the mixing material in the buffer store, independent of a possible input volume flow and in particular independent of an output volume flow. The control device itself can act on corresponding actuators, if these are provided, for example, as mechanical pressure regulators, at which a desired target pressure can be manually or electronically specified, which is then maintained by coupling to a suitable pressure accumulator and opening an outlet channel in the event of excess pressure.

If, for example, pressure is applied by a displaceable piston in connection with a fluid pressure source, a suitable pressure regulator can be provided in the supply line between the buffer store and the fluid source, which enables the desired pressure to be maintained above the piston. In other embodiments, corresponding actuators can be activated via control signals, which make it possible to maintain the pressure at the desired value.

In further advantageous embodiments, the control device is configured to control one or a plurality of further components of the material mixing system and/or to receive corresponding operating parameter values from at least some components of the material mixing system, for example to generate suitable target values for at least the control of the pressurization. For example, the control device can be configured to control corresponding electrical or electromagnetic actuators that are mechanically connected to a piston of the buffer store so that operating parameters for these drive components can also be used to control the pressurization and to evaluate the state of the buffer store. For example, in the case of electrical or electromagnetic control of an actuator, the current consumption at a given travel distance can be evaluated as an indicator of the pressure prevailing in the buffer store without the need for additional sensors. On the other hand, for example, a displacement of the piston caused by the conveyance of mixing material in the buffer store can be evaluated by the control device due to a change in the rotational position of a corresponding motor and used accordingly to continue to exert a desired constant pressure on the mixing material.

Even when the mixing material is pressurized by a pressurizing fluid, such as air, nitrogen, and the like, for example by using a displaceable piston, as described above, the pressurization can be controlled by activating corresponding control elements or actuators, for example in the form of proportional valves and the like, whereby the pressure of the corresponding fluid is recorded and evaluated via corresponding sensors.

If an electronic control unit is used, almost all common microcomputers or microcontrollers are suitable for this purpose, for example in the form of programmable logic controllers (PLC), which have sufficient resources so that sensors can be read out in the range of microseconds to a few milliseconds and corresponding evaluation algorithms can be applied. In this way, a very fast reaction to pressure changes can be achieved, so that stable conditions can be maintained at the outlet of the buffer store, even if rapidly changing volume flows occur. For example, when feeding a curtain nozzle for the application of lacquer or other mixing materials to a printed circuit board, a dynamic change of the spray width can cause a corresponding dynamic change of the volume flows. Due to the presence of the buffer store, these volume flows can be adjusted in a rapid manner, resulting in considerable advantages compared to conventional mixing systems in which the dynamic range of the corresponding metering units and mixing units would not be sufficient.

The control system can also have suitable algorithms, so that the special features and especially the additional possibilities that can be achieved by the buffer store can be utilized compared to conventional mixing systems. For example, by knowing the mixing ratios and material properties, the control device can determine or otherwise obtain the pot lives, for example by retrieving them from a data memory, and the like, and can determine suitable quantities for the mixing material in the buffer store for various requirement profiles with the help of the known parameters of the system, such as the volume of the supply lines, and the like. When connected to the necessary actuators, the control unit can generate suitable control signals to control the operation of the material mixing system in such a way that the requirements for the respective application are met and at the same time the properties of the buffer store are used as optimally as possible. In further embodiments, in which possibly one or a plurality of components of the material mixing system cannot be controlled by the control device, the control device can generate appropriate information at least by knowing the operating parameters of these components and make it available to an operator or a further control system in order to enable an optimized operation of the material mixing system.

In general, in the material mixing system according to the invention with the buffer store with controlled pressurization of the mixing material, the possibility is created to adjust the pressure on the mixing material at the store outlet in a very dynamic way by increasing or reducing the pressurization of the mixing material, so that it is possible to react to different requirements during operation or to different requirements for different runs. For example, as explained above, rapid changes in jet widths in curtain nozzles can be responded to by appropriately adjusting the pressurization of the mixing material in the buffer store to maintain desired precisely defined conditions when applying the mixing material. The controllable pressurization can be carried out independently of the filling quantity of the buffer store, so that, unlike in devices in which an elastic diaphragm or a spring acts on a material or a corresponding piston, a constant pressure can be maintained. This also makes it possible that only a suitable quantity of mixing material is produced and received in the store, which is required for the respective application. This allows mixing materials to be processed with a very short pot life without the risk of the mixing material curing in the supply lines and the buffer store. In other cases, a certain reaction time may be required after mixing the two or plurality of materials, so that in this case an appropriate lead time can be taken into account and the mixing material is received in the buffer store before it is passed on to the applicator. In this case, for example, the volume of the mixing material in the buffer store can be increased.

In general, the buffer store can be provided as a mechanically simple construction, so that a construction of inexpensive disposables is possible. The buffer store can be quickly replaced in a cost-effective manner if, for example, the pot life is significantly exceeded due to a power failure or similar circumstances, which would otherwise lead to costly cleaning of the store.

Further advantageous embodiment are described in more detail with reference to the accompanying drawings, in which

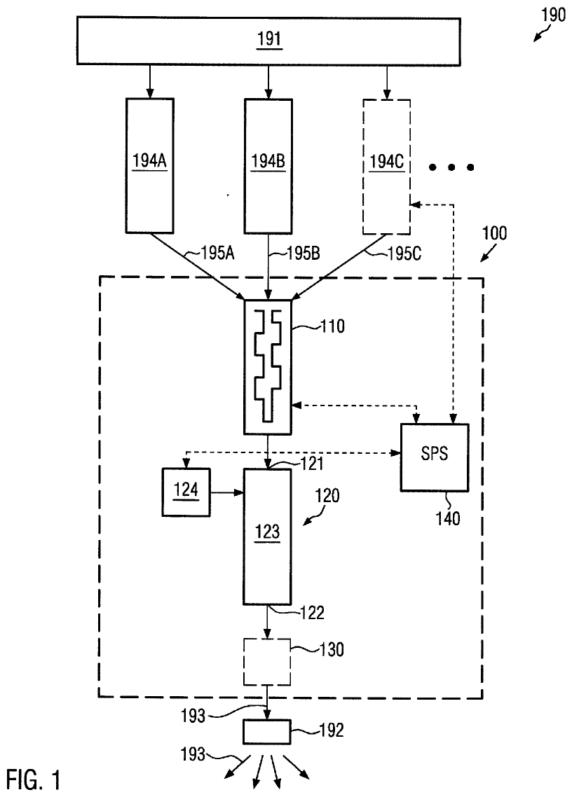

FIG. 1 schematically shows a material mixing system, in which a controlled mixing material buffer store is provided,

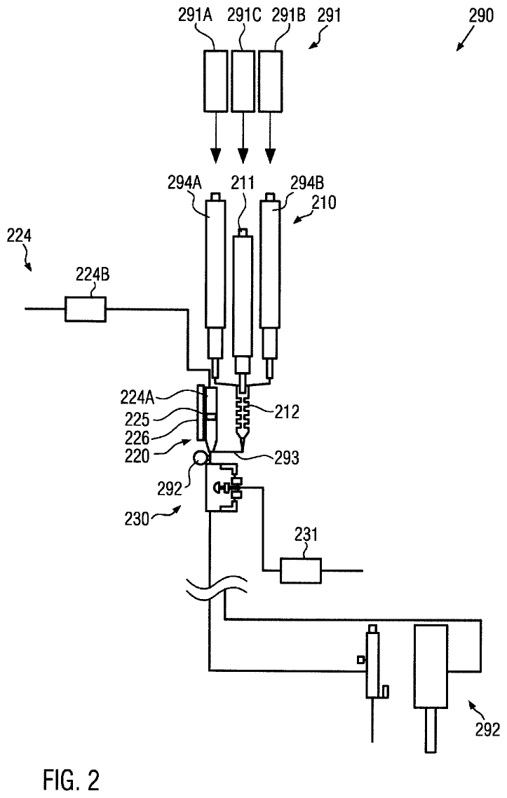

FIG. 2 shows a schematic view of a material mixing system in which the pressure control in the buffer store is implemented by pneumatic control,

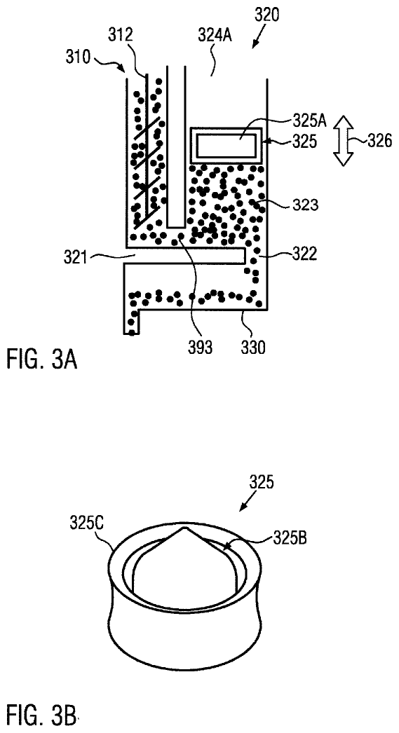

FIG. 3A shows a schematic sectional view of the buffer store according to an illustrative embodiment, in which a displaceable piston is provided for pressurizing the mixing material,

FIG. 3B shows a perspective view of a piston that can be used in embodiments with displaceable pistons, for example the embodiment shown in FIG. 3A,

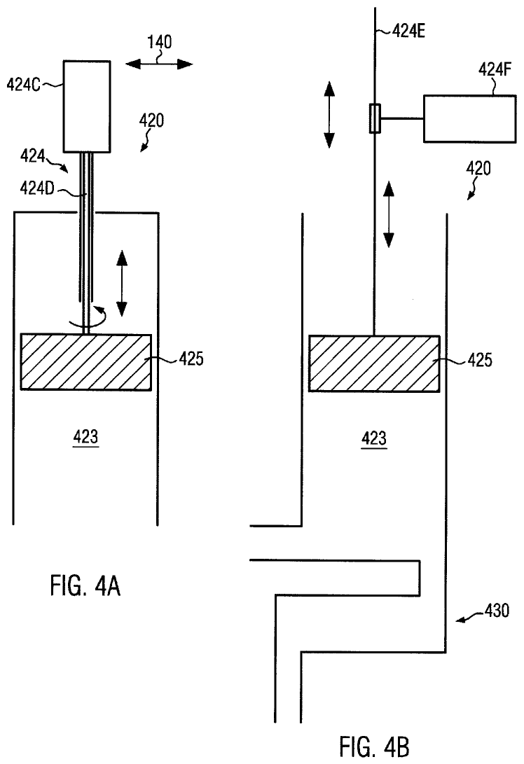

FIGS. 4A and 4B schematically show sectional views of the buffer store, whereby a displaceable piston is provided, which is directly mechanically coupled to an electrical or electromagnetic drive device, and

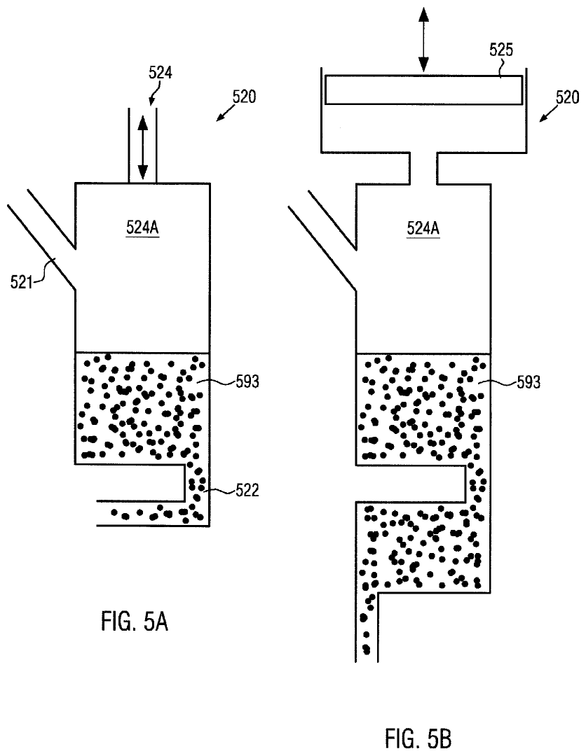

FIGS. 5A and 5B show schematic sectional views of the buffer store, in which the pressurization of the mixing material in the buffer store is effected by the action of a pressurizing fluid, such as a gas, a suitable liquid, and the like.

With reference to the accompanying drawings, further embodiments are now described and/or the previously described embodiments are explained in more detail.

FIG. 1 schematically shows a system 190 for the production and application of a mixing material, which is produced from two or a plurality of components by mixing. The system 190 has a corresponding material source 191 for this purpose, in which corresponding starting materials are typically provided in the form of fluids, whereby the individual components have certain properties that enable reliable transport, storage and processing. Typically, the starting materials are fluids with a manageable viscosity. By mixing two or a plurality of components, the desired material properties are obtained and, as already mentioned at the beginning, a final product is obtained after a certain curing time, which meets the application-specific requirements.

In some of the embodiments shown here, reference is made to a mixing material that is produced from two starting components by mixing, since such 2-component materials are frequently used in industry, for example as filling materials, protective coating materials, and the like. However, it should be noted that the concept according to the invention is also applicable to mixing materials that are mixed together from three or a plurality of components, if this is considered suitable for certain applications.

The material source 191 thus has corresponding containers or other material sources which can provide starting materials with the desired quantity and flow rate by suitable means, for example by pumps, for instance in the form of diaphragm pumps, and the like. The material source 191 typically also has one or a plurality of materials that can be used to flush the system 190, and includes suitable solvents, and the like. It also includes, for example, fluids in the form of gas, such as air, nitrogen, and the like, which can also be provided by suitable means, pressure vessels, and the like. The system 190 also includes a material mixing system 100, which is configured, in accordance with the invention, to achieve significant efficiency improvements over conventional material mixing systems, with the material mixing system 100, in particular, enabling an increased speed of response to dynamically varying acceptance requirements, as described in detail above and in the following.

The system 190 also has a material output component 192, which receives a mixing material 193 from material mixing system 100 and outputs mixing material 193 in a suitable manner. For example, the mixing material output component 192 has one or a plurality of types of nozzles for spraying the mixing material 193 onto an object, with corresponding nozzles typically controllable so that the flow rate depends on the current operating state of the corresponding nozzle. In an advantageous embodiment, the material mixing system 100 according to the invention is used within the framework of the system 190 to apply mixing materials to carrier plates of electronic components so that corresponding components are given additional functions after mounting on the carrier plate, such as protection against environmental influences, and the like.

In other variants, the material system 190 with the mixing material system 100 according to the invention can be used for the production and application of mixing materials in which the mixing material can be processed before a certain period of time of the chemical reaction has elapsed, although with typically increased viscosity compared to the starting materials, and corresponding volume flows of the mixing material 193 are in the range of a few cubic centimeters per minute up to several hundred cubic centimeters per minute. The mixing material system 100 is configured in such a way that a quick response to rapid changes in the decrease quantity in particular is possible. If, for example, the mixing material 193 in the output component 192 has to be provided in a correspondingly time-varying quantity due to flow rates that fluctuate rapidly over time, for example if the spray width of a curtain nozzle is changed dynamically during an application process, the system 100 can then react with a correspondingly high response speed and provide a variable volume flow. In this way, a continuous material quality of the applied mixing material 193 is guaranteed.

As already explained at the beginning, the dynamics of a system for mixing and applying a mixing material is typically given by the mechanical properties of corresponding metering units and the configuration of a mixer, since, for example, the metering units cannot change their throughput at any speed and the mixer also typically has a correspondingly low response speed due to its configuration. In the system 190, for example, well known metering units 194A, 194B, 194C, . . . are provided, which are configured as volumetric units, so that, for example, a corresponding metering screw is provided, which, due to its configuration, conveys a precisely defined quantity of starting material from its inlet to its outlet, provided that it is guaranteed that sufficient starting material from material source 191 is always available at the respective metering units. This means that in well-proven, established volumetric metering units, the quantity per unit of time and thus the volume flow can be precisely adjusted by the speed of the corresponding screw conveyor, for example by controlling the speed of the screw conveyor. In case of rapid changes of the required volume flow, however, due to the limitations of the drive means as well as the mechanical conditions, only a limited dynamic tracking of the required volume flow can be performed.

It should be noted that in the example shown, the metering units 194A, 194B each provide the starting materials for the mixing material 193 in the desired quantity ratio, while the metering unit 194C, for example, can be provided for the metered supply of cleaning material, and the like, if precise metering is required in this respect. In other examples, as explained above, three or a plurality of components may be required for the resulting mixing material 193.

The metered material quantities or volume flows provided by the metering units 194A, 194B, 194C, which are schematically designated here as 195A, 195B, 195C, are fed to a mixing unit 110 of the material mixing system 100, which is schematically represented here in such a way that it can homogeneously mix at least two of the volume flows 159A, 159B. It should be noted that the mixing unit 110 can also be a combination of a plurality of mixing units, if, for example, a plurality of starting materials are to be mixed in several stages, i.e. in several steps. The mixing unit 110 can be a well-known static/dynamic mixing unit in which a mixing helix is statically provided, if, for example, the material properties of the starting materials, such as viscosity, are relatively similar and the materials can be mixed well so that a homogeneous material mixture is produced when passing through the static mixing helix. This is usually limited to certain values of the mixing ratio. In other variants a dynamic, i.e. rotatable mixing helix can be provided in order to achieve a higher degree of flexibility in the homogeneous mixing of the starting material streams.

As explained earlier, when the two or plurality of starting materials come into contact, a corresponding chemical reaction occurs, which typically leads to an increase in viscosity, so that only a limited time is available for further processing of the mixing material 193 as explained earlier.

The material mixing system 100 also includes a mixing material buffer store 120, also known as buffer store, with an inlet 121, which is directly or indirectly connected to the mixing unit 110 to receive the mixing material 193 from the mixing unit 110. Furthermore, an outlet 122 is provided through which the mixing material 193 can be discharged, for example to an optional pre-pressure control 130, which in turn passes the mixing material 193 to the output component 192 at a desired pressure.

The buffer store 120 also has a storage volume 123, which is controllably variable in some embodiments, as already explained or as will be shown in more detail below. It should also be noted that the positions of the inlet 121 and outlet 122 do not necessarily correspond to the positions shown in FIG. 1 and should rather be regarded as functional components only, so that the actual position of the respective connections for inlet 121 and outlet 122 are selected according to the requirements, as explained in more detail below.

The buffer store 120 is a controlled buffer store which applies a controllable pressure to at least the mixing material in it. This means that the buffer store 120 comprises a pressure control 124 or is at least coupled to it, which is suitable for adjusting the pressure prevailing in the storage volume 123 in a suitable manner and for maintaining it within a certain range so that the pressurization of the mixing material in the storage volume 123 takes place at a relatively precisely set value. The pressure control 124 can, for example, be a unit in which a proportional valve, not shown, is controlled in such a way that a pressure from a pressure accumulator (not shown), i.e. a corresponding fluid, is fed into storage volume 123 and thus pressurizes the material in it with the desired pressure. If the pressure in the storage volume 123 changes, for example by further introduction of mixing material from the mixing unit 110, the pressure control 124 is further configured in such a way that a corresponding compensation of the pressure with a short response time, for example in the range of a few milliseconds up to several tens of milliseconds, can be achieved, for example by providing a corresponding bypass path or venting path, not shown. When a pressure source with a pressurizing fluid is used, the pressurizing fluid can act directly on the mixing material or interact with the mixing material via a displaceable piston, as explained in more detail below.

In even further embodiments, the pressure control 124 can take place in the form of a direct mechanical coupling, if, for example, the pressure control 124 includes suitable drive components, such as linear motors, rotary motors with spindle drive, rack and pinion drives, electromagnetic drives that produce a linear effect, and the like. The pressure control 124 may have a control device which, independently of the remaining components of the material mixing system 100, is configured to maintain the corresponding pressure in the storage volume 123, taking into account a corresponding externally specified target value. Mechanical pressure regulators may be provided for this purpose, whereby, for example, the corresponding target value is determined by manually setting an appropriate regulator, and the like. In other embodiments, an electronic control device is provided which acts on corresponding actuators, such as a proportional valve and the like, in order to perform the pressure control in the storage volume 123.

In further illustrative embodiments, an electronic control unit 140 is provided which is configured to take over the function of the pressure control 124, for example by generating corresponding control signals for actuators and/or receiving and evaluating sensor signals or other signals with parameter values of the pressure control 124 or other components of the material mixing system 100, and the like. In advantageous embodiments, the control unit 140 is also functionally connected to at least one other component of the material mixing system 100 and/or the system 190 in order to receive at least parameter values or sensor values and to evaluate them for controlling the buffer store 120. The control unit 140 can be provided in the form of a microcomputer, a microcontroller, and the like, whereby corresponding function modules are implemented, which take over various evaluation and control tasks. It should be noted that modern microcontrollers and programmable logic controllers (PLC) typically have cycle times, i.e. times for a complete run-through of a control algorithm, of one millisecond or less up to several milliseconds, so that a fast response speed is achieved, especially for the control of the buffer store 120.

Furthermore, it should be noted that often certain components, such as electric motors, valves and the like can be connected to corresponding parts of the control unit 140, which have a certain “intelligence” of their own, so that, for example, the execution of control tasks, such as keeping an electric motor position constant, opening or closing valves, and the like is possible in shorter time intervals compared to the cycle time of the control unit 140. For example, corresponding electric motors can be addressed via the control device 140 by merely specifying one or more target values, such as speed and the like, while the actual control loop is implemented in a subordinate unit, for example a stepper motor control, so that the response speed is given by the mechanics of the respective components to be driven and the corresponding subordinate controls.

For example, the control unit 140 can be coupled with corresponding drive motors for the screw conveyors of the metering units 194A, . . . , 194C, so that corresponding target values can be specified, compliance with which is then achieved by the subordinate control system in a very precise manner, without these control loops being influenced by the cycle time of the control unit 140. In the same way, the control device 140 can be connected to the mixing unit 110 in order to specify a corresponding target value for the rotational speed when an active mixing unit is considered, or in order to obtain corresponding operating parameters, for example, current consumption of a corresponding motor, to detect a state of a corresponding mixing helix, and the like. In this way, the operating mode of the buffer store 120 can also be adapted in an optimized way to the interaction of the other components of the system 100 and the system 190.

In one embodiment, the control device 140 is configured to serve as a volume determination device which determines the storage volume on the basis of sensor signals and/or other signals supplied to it, such as from drive components and the like, as described above.

When operating the system 190 with the material mixing system 100, provided that a suitable mixing ratio for the starting materials is already known and the system 190 is in a functional state, the corresponding volume flows 195A, 195B, 195C are fed from the metering units 194A, . . . , 194C to the mixing unit 110, where a homogeneous mixing of the two or plurality of material components then takes place. The produced mixing material 193 is then first fed to the buffer store 120, in which a quantity of mixing material 193 adapted to the application is stored before the mixing material 193 is discharged at the outlet 122. Especially when using the control unit 140, which has stored corresponding application-specific information or otherwise determines or receives this information, the control of the buffer store 120 can then be made application-specific in such a way that a defined volume flow under a desired pressure is output to the output component 192, which applies the mixing material 193 in the desired form to an object, such as a printed circuit board.

For example, the control unit 140 can retrieve or determine parameters for a corresponding application, which concern the pot life of the material 193, the current flow in the output component 192, the current state of the buffer store 120, and the like. In this way it is determined, for example, what quantity of mixing material 193 must first be stored in the buffer store 120 before the application process can begin. If, for example, it is known that a relatively high volume flow is required for the dispensing component 192, for example, to wet relatively large-area components, and the control unit 140 knows the corresponding operating conditions of the metering units 194A, . . . , 194C and the mixing unit 110, then a corresponding quantity to be stored and a corresponding dispensing time can be calculated, taking into account the material properties, i.e., the pot life, before a “recharging” of the buffer store 120 is required.

If, for example, the pot life of the currently used mixing material 193 is relatively long, then for a known required volume flow in the output component 192 it can be determined how much material can be added to the buffer store 120 before the actual application begins. In this way, the output of the mixing material 193 can be adjusted to the special conditions, so that, for example, exactly enough mixing material is stored in the storage 120 so that a certain number of application processes can be reliably carried out without being affected by the increasing viscosity of the mixing material 193. This can also be achieved for a volume flow at the output component 192 that exceeds the maximum possible volume flow of the metering units or the mixing unit 194A, 194C, 110. In this case, the continuous supply of material in the buffer store 120 can also be taken into account in advance to determine the corresponding number of possible application processes and the corresponding quantity of material in buffer store 120.

If, on the other hand, a relatively low volume flow is required at the output component 192, the control device 140 determines a suitable dwell time for the mixing material in the buffer store 120, taking into account the pot life, so that a corresponding smaller quantity may be sufficient. Nevertheless, fluctuations occurring in the process can be compensated due to the high dynamics of the material mixing system 100.

It should be noted that the pre-pressure control 130 is provided in conventional systems in order to maintain a certain “constancy” of the pressurization of the mixing material at the output component, but in the present invention this pre-pressure control 130 may be omitted if necessary, provided that the high response speed of the buffer store 120 to pressure fluctuations is considered sufficient for certain requirements.

FIG. 2 schematically shows a system for generating and applying a mixing material 290, in which a material system 291 has a material source 291A for a first component and a material source 291B for a second material component. The material sources 291A, 291B can be cartridges or other sources providing the two starting materials. In addition, as explained earlier in connection with FIG. 1, a component 291C may be provided, such as a solvent, and the like. The material sources 291A, 2918 are connected to corresponding metering units 294A, 294B, which are provided, for example, in the form of a volumetrically operating system in which a corresponding drive unit of the units 294A or 294B sets a corresponding screw conveyor in motion so that, independent of the pressure and temperature of the input materials, a precisely defined amount of material per unit of time is conveyed, depending on the speed and structure.

The two metering units 294A, 294B are connected to a mixing unit 210, which is configured, for example, as a static-dynamic mixing unit, which is equipped with a drive component 211, for example an electric motor, and a mixing helix 212. In the case of dynamic mixing, as explained above, the mixing helix 212 is set in rotation by the motor 211 in order to achieve the most homogeneous possible mixing of a mixing material 293 even with very different material properties and/or a large mixing ratio. The mixing unit 210 is connected to a mixing material buffer store or buffer store 220, to whose inlet 221 the mixing material 293 is fed. An outlet 222 is located near the inlet 221 and is connected to an inlet pressure control 230, which in turn is connected to an output component 292, such as a Jetter nozzle and/or a curtain nozzle, and the like.

The mixing unit 210 in combination with the buffer store 220 and the optional pre-pressure control 230 correspond to a material mixing system according to the invention, as it is explained above in connection with the system 100. In this variant, the buffer store 220 is, for example, configured as a cylindrical hollow body, which is made of inexpensive materials, such as PTFE, although other materials are also available, such as aluminum, and the like.

The buffer store 220 has a displaceable piston 225, which thus serves to pressurize the mixing material 293 inside the buffer store and at the same time determines the effective storage volume of the buffer store 220. This means that on a side of the piston 225 facing away from the mixing material 293, a fluid storage volume 224A is defined, which is filled with a pressurizing fluid, such as air, nitrogen, and the like, or also a liquid, so that on the one hand the desired pressure is exerted on the piston 225 and on the other hand a corresponding variable adjustment of the effective storage volume for the mixing material 293 is achieved by appropriate supply and discharge of fluid from the fluid storage volume 224A.

In the embodiment shown, for example, a pressure control 224 for the mixing material 293 is achieved by coupling a suitable fluid source (not shown) to the fluid storage volume 224A above the piston 225 and by providing a corresponding actuator 224B which is capable of controlling and maintaining the pressure in the fluid storage volume 224A at a desired value. For example, the component 224B may include a proportional by-pass valve so that an appropriate amount of fluid can be supplied from the pressure reservoir, not shown, so that a desired pressure is maintained even with a variable amount of mixing material 293, whereas an increase in volume of the mixing material 293 and a resulting force exerted by mixing material 293 on piston 225 allows fluid to escape from fluid storage volume 224A in a controlled manner. As explained above, the pressure control 224 can be achieved by means of an electronic control device or manual controls can be used to maintain the desired pressure conditions in the fluid storage volume 224A.

Furthermore, in the embodiment shown, a sensor 226 is provided which detects the position of the displaceable piston 225. The sensor 226 can, for example, be configured as an analog path sensor that responds to a corresponding indicator material in the displaceable piston 225. For example, the corresponding indicator material can be provided as a magnet in the piston 225. By detecting the position of the displaceable piston 225, a control device, not shown, such as the control device 140 of FIG. 1, can determine the current value of the effective storage volume so that the quantity of the mixing material 293 present in the buffer store 220 is known at any time. Although the actual quantity of the mixing material 293 can also be obtained on the basis of “indirect” values, as explained above in connection with FIG. 1, the sensor 226 provides a very precise and well temporally well resolved positional information for the displaceable piston 225. In other variants, other sensors can be used, such as a series of discretely arranged reed switches, etc. An electromagnetic coupling between the displaceable piston 225 and a corresponding sensor, which is mounted on the outside of the buffer store 220, can also be used to detect the position of the displaceable piston 225 in a contact-free manner.

Furthermore, it also applies to the system 290 and the material mixing system with components 210, 220 and 230 that in general the control of the buffer store 220 and at least one other component can be carried out via a corresponding electronic control device, as explained in connection with FIG. 1. For example, the drive components of the metering units 294A, 294B, the motor 211 of the mixing unit 210 can also be controlled by or under the instruction of a corresponding electronic control device, or at least corresponding operating parameters are provided for a corresponding control device so that the status of the system 290 can be evaluated, in particular to control the operation of the buffer store 220 taking into account the status of the system 290.

During the operation of the system 290, the materials 291A, 291B are discharged according to a previously determined mixing ratio from the metering units 294A, 294B to the mixing unit 210, in which the two components are mixed as homogeneously as possible, for example statically or dynamically, depending on the starting materials, their mixing ratio, and the like. The mixing material 293 is fed to the inlet 221 at a lower area of the buffer store 220, so that against the pressure of the piston 225 the mixing unit 210 conveys the material 293 into the buffer store 220. This means that by moving the piston 225, the introduced mixing material 293 is pressurized by the piston 225 with the pressure which is present in the fluid storage volume 224A and is kept essentially constant by the pressure control 224. If mixing unit 210 continues to operate, further mixing material 293 is introduced into the buffer store 220 against the pressure of the piston 225, while maintaining a relatively constant pressure in the volume 224A. As explained above, the pressure control 224 is configured in such a way that when the fluid storage volume 224A is reduced, fluid can escape, for example to the outside or into a fluid reservoir, not shown, so that the desired pressure is maintained.

If, on the other hand, mixing material 293 is discharged from outlet 222 by activating the output component 292, the position of the piston 225 may change downwards depending on the feeding volume flow generated by mixing unit 210, so that control component 224B then ensures that the desired constant pressure is maintained in fluid storage volume 224A. If a change in volume flow occurs, for example, due to a change in the jet width of a curtain nozzle, the corresponding resulting pressure fluctuation can be absorbed by pressure control 224 without causing a noticeable change in the pressurization of the mixing material 293. For example, if there is a rapid increase in volume flow to the output component 292, the corresponding decrease in storage volume is compensated by a corresponding movement of the piston 225 and a further introduction of pressurizing fluid into volume 224A, so that very constant pressure conditions continue to exist at the output component 292. The same applies to a reduction of the volume flow if, at about the same time, there is still an inflow of material from the mixing unit 210, so that an increase in material in the buffer store 220 is compensated accordingly.

As explained above, an electronic control device, not shown, such as the control device 140 described in connection with FIG. 1, can determine a suitable operating mode for a particular application in advance or dynamically for the buffer store 220. For example, a minimum effective storage volume can be determined which is necessary to reliably enable the operation of output component 292 so that, when this minimum storage volume is reached, corresponding material from mixing unit 210 must be delivered in to buffer store 220. For this purpose, for a known profile of the output of mixing material 293, a corresponding quantity of mixing material 293 can be determined, which is necessary for the reliable supply at the given profile in order to ensure the operation of the output component 292 for a corresponding period of time. On the other hand, a maximum effective storage size can also be determined for this purpose, which is determined as a function of the pot life, so that when filling the buffer store 220, no excessive quantities of the mixing material 293 are loaded, which could otherwise contribute to premature curing of the material and thus to the inoperability of the entire system 290.

In a simple case, such values for the minimum and maximum storage size can be specified as a function of the position of the displaceable piston 225, so that when the minimum piston position is reached, a corresponding signal is sent to the mixing unit 210, and thus also to the metering units 294A, 294B, so that material is mixed again and the buffer store 220 is loaded, if the operation of these units was previously interrupted. Similarly, when the maximum piston position is reached, the further supply of material is interrupted, so that the dwell time of the mixing material 293 in the buffer store 220 is in an uncritical range with respect to the pot life. For example, a position determined as the maximum piston position for this particular application can be defined in such a way that the mixing unit 210 can be reliably emptied in any case without exceeding the critical storage volume in terms of pot life, while at the same time preventing curing of mixing material in mixing unit 210 as far as possible.

Due to the dynamically controllable storage function of the buffer store 220, especially the mixing unit 210 and the metering units 291A, 291B can be operated in a reliable, possibly relatively limited working range, while still allowing a high dynamics with regard to the volume flow to be provided. In other words, in applications where a high average volume flow in the output component 292 is required, the component 292 can be operated intermittently if the inflow from mixing unit 210 is smaller than the average outflow from the buffer store 220. In this case, suitable minimum and maximum storage volumes are determined so that the output component 292 can be operated reliably and under precisely defined operating conditions for appropriate periods of time, while the buffer store 220 can be filled appropriately during respective operating stops. The metering units 294A, 294B and the mixing unit 210 can be operated continuously without affecting the output pressure during the active phases of the output component 292.

In addition, pressure transducers may be provided at suitable points to monitor the condition of the system 290, for example after the metering units 294A, 2948 and after the buffer store 220. By determining the pressure conditions, various conditions of the system 290 can be detected, for example a reduction in the “permeability” of a section of pipe, and the like. The values of the pressure transducers can also be used to control the operation of the buffer store 220, whereby it is advantageous to use an electronic control device, such as the control device 140 in FIG. 1,

FIG. 3A shows a schematic sectional view of a mixing material buffer store 320, briefly referred to as buffer store, which can be used, for example, in the embodiments shown above with reference to FIGS. 1 and 2. The buffer store 320 is part of a material mixing system, e.g. the system 110, which is shown in FIG. 1. The buffer store 320 is therefore connected to a mixing unit 310, which, for example, has a dynamically driven mixing helix 312, in which two or a plurality of material components are mixed as homogeneously as possible, so that a mixing material 393 is formed, which is introduced into the buffer store 320 via an inlet 321, i.e. a passage between the mixing unit 310 and a storage volume 323. The mixing material 393 leaves the storage volume 323 via an outlet 322, which is configured, for example, as a fluid passage to a corresponding supply line for an output component.

In the embodiment shown, the outlet 322 is connected to a pre-pressure control 330, which, for example, has a further pressure inlet not shown, in order to apply further pressure to the mixing material 393. In other illustrative configurations, pressure can be applied exclusively via the store 320, so that a further volume is not required to pressurize the mixing material 393 before it is fed to a corresponding output component.

In the embodiment shown, a mechanically simple structure results from the fact that the inlet 321 is directly coupled with the mixing unit 310 as a fluid passage and the outlet is also directly coupled as a fluid passage with the inlet pressure control 330 or a corresponding outlet line.

Furthermore, a displaceable piston 325 is provided, which leads to a division of the total volume of the fluid reservoir 320 into the effective reservoir volume 323 and into a fluid reservoir volume 324A, which in the embodiment shown is charged with a suitable fluid in order to apply a desired pressure to the mixing material 393 via the displaceable piston 325, as explained above. In advantageous embodiments, the fluid reservoir volume 324A is filled with air or nitrogen and thus represents a pneumatic pressure control for the buffer store 320. The fluid piston 325 has a suitable indicator material 325A, which enables the position of the fluid piston 325 to be detected by a position sensor shown schematically as 326. For example, the indicator material 325A is provided in the form of a magnet and the sensor 326 is an analogously working sensor, so that an almost continuous detection of the current position of the piston 325 is possible. Due to this arrangement, the configuration of the housing of the fluid reservoir 320 can be kept simple, since no corresponding through holes and the like are required for internal sensors.

In general, the configuration of the fluid reservoir 320 of the embodiment shown is such that the number of dead spaces is kept as low as possible, which is also helped by the contact-free coupling of the indicator material 225A with the sensor 326. It should be noted that the illustrations in FIG. 3A are very schematic and the corresponding feed-throughs and lines, for example in the form of the inlet 321 of the outlet 323 and the line run in the pre-pressure control 330, are actually configured in such a way that the flow of the mixing material 393 is as low-resistant as possible without corresponding areas with flow standstill. For example, the 90° corners shown in the drawing are rounded accordingly in practice.

The function of the buffer store 320 is similar to the function described above in connection with FIGS. 1 and 2. This means that the mixing unit 310 feeds the interior of the buffer store 320 with the mixing material 393, which thus displaces the displaceable piston 325 against the pressure exerted on the piston 325 in the fluid storage volume 324A, so that the mixing material 393 is thus subjected to the pressure that is set in a controlled manner in the fluid storage volume 324A. As material continues to be fed through the mixing unit 310, the quantity 393 in the effective storage volume 323 increases when the outflow is less than the inflow. On the other hand, the storage volume decreases if the outflow is higher than the inflow. As explained above, by detecting the current position of the piston 325, the corresponding actual storage volume and thus the material quantity 393 can be determined, so that suitable operating conditions are always maintained, which are determined depending on the pot life, the application process, the capabilities of the mixing unit 310 and the upstream metering units, and the like. Also in this case, the operating mode of the buffer store 320 and one or a plurality of further components can be controlled by an electronic control device, such as the control device 140 shown in FIG. 1.

FIG. 3B shows a schematic perspective view of a possible embodiment of the displaceable piston 325. In the embodiment shown, a suitable outer material 325C is provided which is compatible with the properties of the mixing material. For example, a material can be selected in the same way as it is used for conventional material cartridges. In this way a very tight seal can be achieved between the effective storage volume 323 and the fluid storage volume 324A (see FIG. 3A). Furthermore, an underside 3258 of piston 325 can be configured so that when a mechanically lowest position is reached in the buffer store, complete closure of inlet 321 and/or outlet 322 (see FIG. 3A) is prevented, so that the buffer store can still be charged with material in this position. A corresponding arrangement is therefore favorable for operating conditions in which it is advantageous to empty the buffer store almost completely. For example, when calibrating the buffer store and/or the metering units and when determining suitable metering ratios, emptying the buffer store can facilitate a more precise determination of calibration values and parameters. Furthermore, as explained above, the piston 325 may have a suitable indicator material, such as the material 325A from FIG. 3A, which is encased by the outer material 325C.

FIG. 4A shows a schematic sectional view of a buffer store 420, which can also be used in the material mixing systems explained above. In the variant shown, the buffer store 420 has a displaceable piston 425, which thus dynamically adjusts an effective storage volume 423 and therefore directly applies pressure to a corresponding mixing material (not shown), as described above in connection with the embodiments of FIGS. 2 and 3A, 3B. However, in the case of pressure control by means of a fluid, an electric or electromagnetic pressure control 424 is provided, which has a drive unit 424C, for example in the form of a rotating electric motor, and a corresponding unit for converting the rotary motion into a linear motion 424D. For example, corresponding linear drives are well known as spindle drives. By controlling the 424C drive unit, the piston 425 can thus be moved and, in case of contact with the mixing material, a desired pressure can be exerted, which can be precisely adjusted by operating parameters of the 424C drive unit. For example, the drive unit 424C can be coupled with a suitable control device, such as the control device 140 shown in FIG. 1, with the interposition of appropriate control components, such as a converter, and the like, so that an exact position and/or pressure for the piston 425 can be set.

For example, by monitoring the corresponding motor speed, the current position of the piston 425 can be evaluated directly and, for example, when mixing material is fed into the buffer store 420, the correspondingly caused displacement of the piston 425 can be read out via a corresponding step counter, position sensor, and the like for the drive unit 424C. At the same time, the force on the piston 425 can also be precisely determined by a corresponding target value for the torque of the drive unit 424C, so that a desired constant pressurization of the mixing material results. The reaction time of the system consisting of piston 425 and pressure control 424 is in the range of typical pneumatic pressure control systems or even below, whereby the use of electrical or electromagnetic components in particular contributes to the higher energy efficiency of an overall system. The piston 425 can also be provided without additional indicator materials and the like, since precise position determination is guaranteed by the drive unit 424C and the associated electronic control unit.

Furthermore, it is also possible to detect an impermissible or cured state of a mixing material by evaluating the corresponding change in position of the piston 425 and the current to be memorized by the drive unit 424C.

FIG. 4B schematically shows another variant in which a linear displacement of the piston 425 is made possible by an electric or electromagnetic drive device. For this purpose, for example, a rotary motor 424F is provided in conjunction with a rack 424E, which is directly coupled to the piston 425. In this way too, the position of piston 425 and the pressure exerted on the mixing material in storage volume 423 can be reliably determined. With regard to the control of the drive unit 424F, essentially the same criteria apply as explained above.

Furthermore, this embodiment shows a pre-pressure control 430, which can also be used in the embodiment shown in FIG. 4A, if the pressure control by means of the buffer store 420 is to be further improved in dynamics.

It should be noted that the electrical or electromagnetic drive systems shown in FIGS. 4A and 4B are also intended to be representative of other electromagnetic drive systems, such as linear motors, which allow direct linear motion without the detour of rotary motion, or electromagnetic systems in which a plunger in an electromagnet is directly coupled to piston 425. Also included are electromagnetic systems in which the piston 425 itself serves as a drive component, for example by representing a part of a magnetic circuit, whereby, according to the reluctance principle, a displacement of the piston 425 is caused by suitable generation of a magnetic field.

FIG. 5A shows a variant of a buffer store 520, which can be used in the material mixing system 100 of FIG. 1, for example. In the buffer store 520, for example, a pressurizing fluid, which is schematically provided as 524A as part of a pressure control 524, is in direct contact with a mixing material 593. For this purpose, the pressurizing fluid 524A is preferably provided as an essentially inert material with respect to the mixing material 593. This means that suitable liquids and/or gases can be used which do not essentially affect the chemical reaction taking place in the mixing material 593. The pressure control 524 is configured so that the fluid 524A is introduced into the buffer store 520 in such a way that a desired pressure is always maintained in the storage 520. This can be done, for example, by means of appropriate pneumatic or hydraulic components, as explained above. If necessary, an appropriate shut-off device can be provided at an inlet 521 and/or an outlet 522 of the storage to prevent fluid from flowing out when the storage is completely empty. In other embodiments, the corresponding fluid 524A is sucked off accordingly when the buffer store is completely empty.

Here, too, the compression caused by the decrease in volume of the fluid 524A when gaseous fluids are considered, or the force exerted on the fluid 524A when incompressible fluids are considered, is compensated in the pressure control 524 by discharging fluid into a corresponding storage, so that the material 593 is still pressurized with the same pressure. On the other hand, more fluid is supplied if the effective volume in the buffer store 520 is reduced by draining the mixing material 593.

In the embodiment shown, the inlet 521, which is coupled to a corresponding mixing unit, is also provided remotely from outlet 522, so that incoming new mixing material is applied to already existing mixing material, so that the material that has been in the storage for the longest time is always discharged via the outlet 522, so that the problem of pot life can be defused even further, since the material with the longest dwell time is always discharged. Again, the inlet 521 and the outlet 522 are configured to achieve the lowest possible flow resistance and almost no dead spaces.

FIG. 5B shows another variant of the buffer store 520, where the mixing material 593 is in direct contact with the pressurizing fluid 524A, but this is also pressurized by a displaceable piston 525 in order to compensate for the volume changes at the desired pressure. The displaceable piston 525 can be driven pneumatically, mechanically, etc., as explained above.

The direct contact of the pressurizing fluid 524A with the mixing material 593 can lead to a more trouble-free operation, in particular, since, for example, mechanical deficiencies in connection with a displaceable piston that is directly in contact with the mixing material can be largely avoided. For example, cured residues of mixing material in the area of the inner surface of the buffer store, which is also the sliding surface with the piston, can lead to disturbances of the piston movement. In addition, the fluid 524A can be replaced in a suitable manner or even used as a flushing agent if the interior of the buffer store 520 must be cleaned after a successful run.

The present invention thus provides a material mixing system which offers a mode of operation with significantly higher dynamics compared to conventional mixing systems, since the pressure-regulated buffer store allows a higher degree of flexibility to react to different requirements when applying a mixing material. The mode of operation of the buffer store can be efficiently integrated into the general control cycle of a corresponding material mixing system and a higher-level mixing material production and application system. For example, when calibrating, setting mixing ratios, and the like, the buffer store can be controlled to a precisely defined operating state so that correspondingly obtained results can be obtained with the same precision as with conventional systems.

1. Material mixing system which is configured for use in a production line for electronic assemblies for providing a viscous material stream, comprising:
a mixing unit adapted to mix two or more inlet material streams to produce a mixing material, and
a mixing material buffer store unit having an inlet for receiving the mixing material from the mixing unit and an outlet for dispensing the mixing material and adapted to pressurize the mixing material in a controlled manner, and
a control device which is adapted at least to control the pressurization of the mixing material in order to maintain at least the pressure in the buffer store which acts on the mixing material, on the basis of an adjustable target value, independently of the quantity of the mixing material in the buffer store, independently of a possible input volume flow and independently of an output volume flow.

2. Material mixing system according to claim 2, wherein an effective storage volume of the mixing material buffer store is dynamically adjustable.

3. Material mixing system according to claim 1, wherein the mixing material buffer store has a displaceable piston.

4. Material mixing system according to claim 3, wherein the displaceable piston communicates with a controllable fluid pressure source on a side facing away from the mixing material.

5. Material mixing system according to claim 3, wherein the displaceable piston is connected to a controllable electrical or electromagnetic drive device.

6. Material mixing system according to claim 1, wherein a fluid substantially inert for the mixing material can be controllably introduced into the mixing material buffer store for pressurizing the mixing material.

7. Material mixing system according to claim 1, further comprising volume determination means adapted to determine an actual volume of mixing material in the mixing material buffer store.

8. Material mixing system according to claim 3, which is further configured to determine a position of the displaceable piston in the mixing material buffer store.

9. Material mixing system according to claim 8, wherein the displaceable piston has an indicator element which enables a position of the displaceable piston to be determined contact-less.

10. Material mixing system according to claim 1, further comprising control means adapted at least to control the pressurization of the mixing material.

11. An electronic assembly production line material mixing system for providing a viscous material stream comprising:
a source of starting materials used in electronic assembly production;
a plurality of metering units coupled to said source of starting materials;
a mixing unit having a mixing unit inlet coupled to said plurality of mixing units and a mixing unit outlet;
a buffer store coupled to the mixing unit outlet, said buffer store having a buffer store outlet;
a material output component coupled to the buffer store outlet, whereby said material output component is capable of providing the viscous material stream to a component of an electronic assembly;
a pressure control device coupled to said buffer store configured to provide a controlled pressure to said buffer store;
a control unit coupled to said plurality of metering units, said mixing unit, and said pressure control device, said control unit configured to provide a controlled pressurization to said buffer store so as to maintain a defined volume flow and output pressure of the viscous material stream from said material output component independent of a quantity of material in said buffer store, a material flow from the mixing unit outlet of said mixing unit into said buffer store, and a material flow from the buffer store outlet of said buffer store to said material output component,
whereby a high dynamic range of the viscous material stream is capable of being maintained.
